(19) United States
(12) Patent Application Publication
(10) Pub. No.: US 2008/0276160 A1
(43) Pub. Date: Nov. 6, 2008

(54) DATA STRUCTURE SUITABLE FOR BROWSING AND MANAGING CONTENTS STORED IN STORAGE MEDIUM

(75) Inventor: Hiroaki Suzuki, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 12/171,136

(22) Filed: Jul. 10, 2008

Related U.S. Application Data
(63) Continuation-in-part of application No. PCT/JP2006/325381, filed on Dec. 20, 2006.

(30) Foreign Application Priority Data
Jan. 13, 2006 (JP) 2006-006803

(51) Int. Cl. G06F 17/00

(52) U.S. Cl. 715/205

(57) ABSTRACT

A memory card has a data structure including three kinds of files: page files as a content main body to be displayed on a display section; a content management file that manages the page files belonging to each content; a total management file that manages all the content management files stored in the memory card. When retrieving page information, a CPU is configured to firstly access the total management file, secondly the content management file, and finally the page files.

### CROSS REFERENCE TO RELATED APPLICATION

This application claims priority from Japanese Patent. Application No. 2006-006803 filed Jan. 13, 2006. This application is also a continuation-in-part of International Application No. PCT/JP2006/325381 filed Dec. 20, 2006 in Japan Patent Office as a Receiving Office. The contents of both applications are incorporated herein by reference.

### TECHNICAL FIELD

The present invention relates to a data structure for managing contents.

### BACKGROUND

A conventional information browsing terminal has a storage medium such as a memory card and stores data of user's desired contents in the storage medium, thereby enabling browsing the contents on the information browsing terminal. However, when the number of contents to be stored increases, information processing load may also increase and consequently adversely affect the processing speed.

Japanese Patent Application No. 2000-348057 discloses a method in which one management file (management information) is provided for describing information on the contents stored in such a storage medium.

However, in the conventional method described above, the size of the management file becomes larger when the number of contents stored in the storage medium increases. Accordingly, access load to the management file also increases, leading to high information processing load.

In view of the foregoing, it is an object of the present invention to provide a data structure, a storage medium, a browsing terminal, a management information generation apparatus, and a management information generation program that can suppress information processing load even when the number of contents to be dealt with increases.

### SUMMARY

In order to attain the above and other objects, the invention provides a data structure for allowing a user to browse a content on a computer. The data structure includes page information, content management information, and total management information. The page information has one page worth of data including at least one of text and image data, one or a plurality of pieces of the page information constituting the content. The content management information is provided for each content and has first link information navigating to each piece of the page information. The total management information has second link information navigating to the content management information. The data structure is configured so that the computer can firstly access the total management information and is navigated to the content management information by virtue of the second link information, and then to the page information by virtue of the first link information when retrieving the page information.

According to another aspect of the invention, there is also provided a computer-readable storage medium that stores data having a data structure including page information, content management information, and total management information. The page information has one page worth of data including at least one of text and image data, one or a plurality of pieces of the page information constituting the content. The content management information is provided for each content and has first link information to navigating to each piece of the page information. The total management information has second link information navigating to the content management information. The data structure is configured so that the computer can firstly access the total management information and is navigated to the content management information by virtue of the second link information, and then to the page information by virtue of the first link information when retrieving the page information. The term “computer” used herein refers not only to a browsing terminal but also to a personal computer as will be described later.

According to still another aspect of the invention, there is also provided a storage medium that stores a computer-executable program having a set of program instructions including generating and storing page information, content management information, and total management information. The page information has one page worth of data including at least one of text and image data, and one or a plurality of pieces of the page information constitutes the content. The content management information is provided for each content and has first link information navigating to each piece of the page information belonging to the same content. The total management information has second link information navigating to the content management information.

According to further aspect of the invention, there is also provided a browsing terminal for allowing a user to browse a content thereon. The browsing terminal includes page information, a display section, a storing section, and a retrieving section. The page information has one page worth of data including at least one of text and image data and one or a plurality of pieces of the page information constitutes the content. The display section displays the page information. The storing section stores the page information, content management information and total management information, the content management information being provided for each content and having first link information navigating to each piece of the page information, and the total management information having second link information navigating to the content management information. The retrieving section retrieves the page information from the storing section when a user inputs a display request for requesting the display section to display the page information, and outputs the page information to the display section. The retrieving section is configured to firstly access the total management information and be navigated to the content management information by virtue of the second link information, and then to the page information by virtue of the first link information when retrieving the page information.

According to further aspect of the invention, there is also provided a management information generation apparatus that generates content management information. The page information has one page worth of data including at least one of text and image data, one or a plurality of pieces of the page information constituting the content. The content management information is provided for each content and has first link information navigating to each piece of the page information belonging to the same content. The management information generation apparatus includes a page storing section, a content management information generating section, and a transmitting section. The page storing section stores the page information. The content management information generating section generates the content management information for each content. The transmitting section transmits the page information and the content management information to a browsing terminal for browsing the page information thereon.

According to further aspect of the invention, there is also provided a management information generation apparatus that stores a set of program instructions executable on a computer. The set of program instructions includes generating and storing page information, generating and storing content management information for each content, generating and storing total management information, updating the total management information, and transmitting information to a browsing terminal. The page information has one page worth of data including at least one of text and image data, one or a plurality of pieces of the page information constituting the content. The content management information has first link information navigating to each piece of the page information belonging to the same content. The total management information has second link information navigating to the content management information. When a plurality of contents is to be transmitted, the management information generation apparatus having the set of program instructions transmits, for each content, firstly the page information, secondly the content management information, and finally the total management information, to a browsing terminal for browsing the page information on the browsing terminal.

### BRIEF DESCRIPTION OF THE DRAWINGS

The particular features and advantages of the invention as well as other objects will become apparent from the following description taken in connection with the accompanying drawings, in which:

FIG. 1 is a block diagram showing a configuration of a browsing terminal 1;

FIG. 2 is a front view of the browsing terminal 1;

FIG. 3 is a diagram showing a data structure of a memory card 13;

FIG. 4 is an explanatory view showing a content selection screen of the browsing terminal 1;

FIG. 5 is a flowchart of a power-triggered process executed when the power of the browsing terminal 1 is turned on;

FIG. 6 is a flowchart of a key input waiting process executed in the power-triggered process;

FIG. 7 is a flowchart showing a content selection process executed in the power-triggered process;

FIG. 8 is a flowchart showing a content determination process executed in the power-triggered process;

FIG. 9 is a flowchart showing a page-turning process executed in the power-triggered process;

FIG. 10 is a flowchart showing a content selection screen display process executed in the power-triggered process;

FIG. 11 is a flowchart showing a content deletion process executed in the power-triggered process;

FIG. 12 is a diagram showing a data structure after the content deletion process is executed for specified content;

FIG. 13 is a flowchart showing a PC connection process executed when the browsing terminal 1 is connected to a PC;

FIG. 14 is a flowchart showing a content main body deletion process executed in the PC connection process;

FIG. 15(a) is a flowchart showing a download process executed in the PC connection process;

FIG. 15(b) is a flowchart showing a total management file updating process executed in the download process;

FIG. 15(c) is an explanatory view showing a total management file 131 obtained after S271 of FIG. 15 (b);

FIG. 15(d) is an explanatory view showing the total management file 131 obtained after S272 of FIG. 15 (b);

FIG. 15(e) is an explanatory view showing the total management file 131 obtained after of S273 of FIG. 15 (b);

FIG. 16(a) is an explanatory view showing a page file 133d generated through the download process;

FIG. 16(b) is an explanatory view showing a content management file 132d generated from the page file 133d through the download process;

FIG. 17 is a functional block diagram of a management information generation apparatus 5;

FIG. 18 is a flowchart showing a file generation process;

FIG. 19(a) is an explanatory view showing the content management file 132d obtained after S303 of FIG. 18;

FIG. 19(b) is an explanatory view showing the content management file 132d obtained after S304 of FIG. 18;

FIG. 19(c) is an explanatory view showing the content management file 132d obtained after S307 of FIG. 18;

FIG. 19(d) is an explanatory view showing the content management file 132d obtained after S309 of FIG. 18;

FIG. 19(e) is an explanatory view showing the content management file 132d obtained after S310 of FIG. 18;

FIG. 19(f) is an explanatory view showing the content management file 132d obtained after S310 (after third loop) of FIG. 18;

FIG. 20 is a flowchart showing a page file generation process executed in the file generation process;

FIG. 21 is an explanatory view showing the page file 133d obtained after S322 of FIG. 20;

FIG. 22 is a flowchart showing a total management file updating process executed in the file generation process; and

FIG. 23 is an explanatory view showing a data structure of the memory card 13 storing a page file having a plurality of pages.

### DETAILED DESCRIPTION

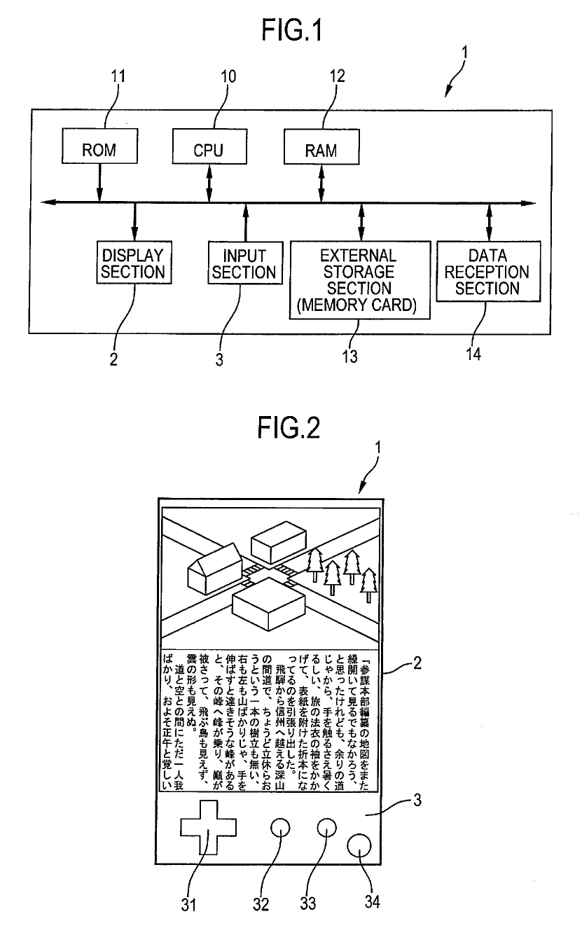

Hereinafter, embodiments of the present invention will be described with reference to the accompanying drawings. A browsing terminal is provided for browsing page information. A memory card stores the page information. A management information generation apparatus generates page information and content management information and transmits both to the browsing terminal. First, the configuration of a browsing terminal 1 will be described with reference to FIGS. 1 through 4. FIG. 1 is a block diagram showing a configuration of the browsing terminal 1. FIG. 2 is a front view of the browsing terminal 1.

As shown in FIG. 1, the browsing terminal 1 includes a CPU 10, an ROM 11, an RAM 12, a display section 2, an input section 3, a memory card 13, and a data reception section 14, all of which are connected to one another via a bus. The CPU 10 controls the entire operation of the browsing terminal 1, the ROM 11 stores a program and the like, the RAM 12 temporarily stores data, and the memory card 13 stores content. The display section 2 displays the content stored in the memory card 13. As shown in FIG. 2, the input section 3 includes a cross key 31, a determination button 32, a cancel button 33, and a delete button 34.

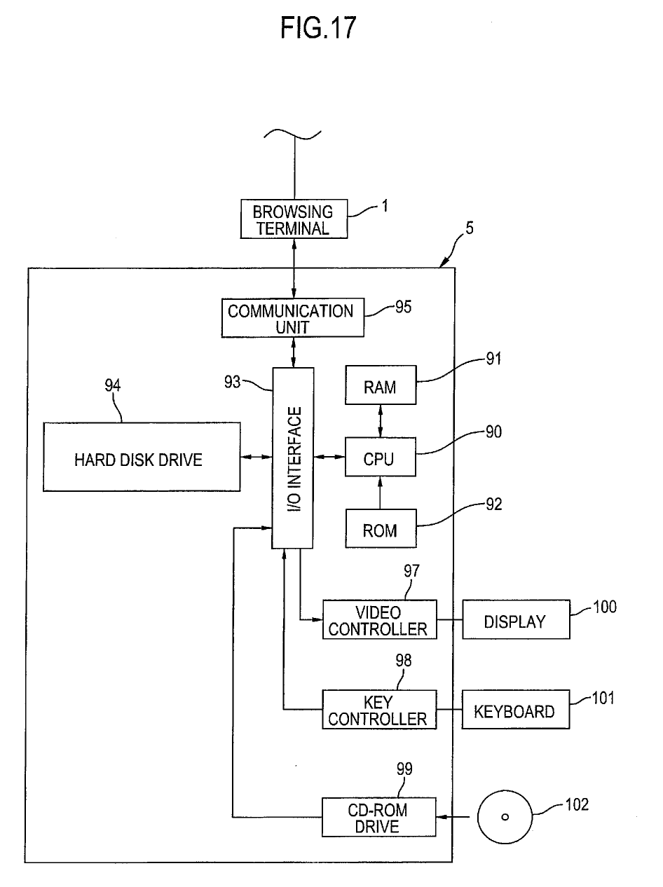

The browsing terminal 1 is always driven by a battery (not shown) and executes charging, download of a page file (to be described later) and deletion of a page file when connected to a PC that constitutes a management information generation apparatus 5 (see FIG. 17).

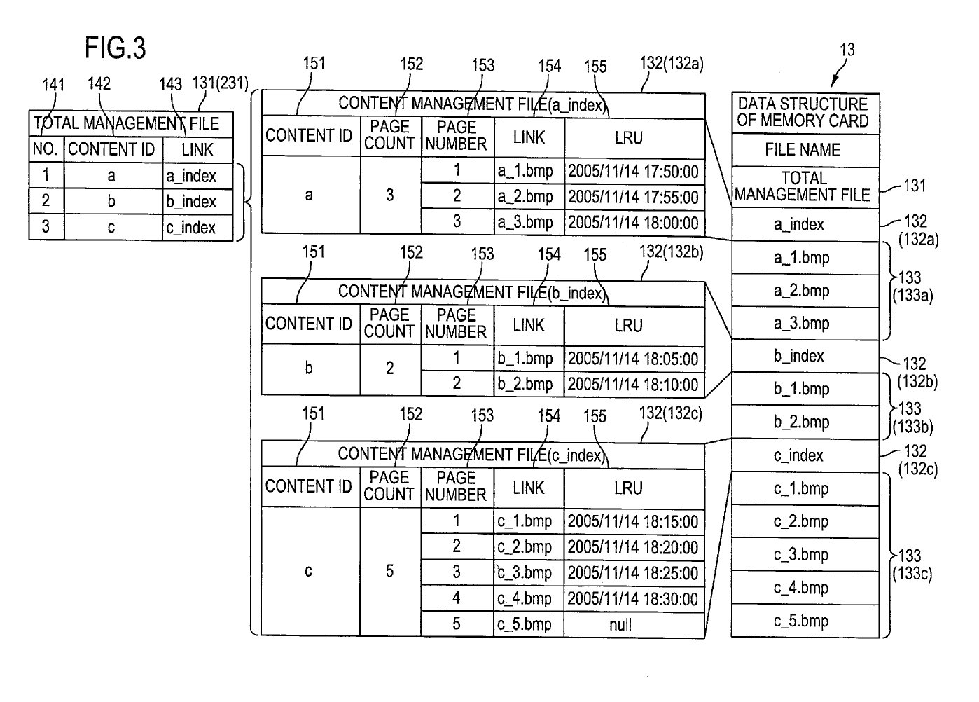

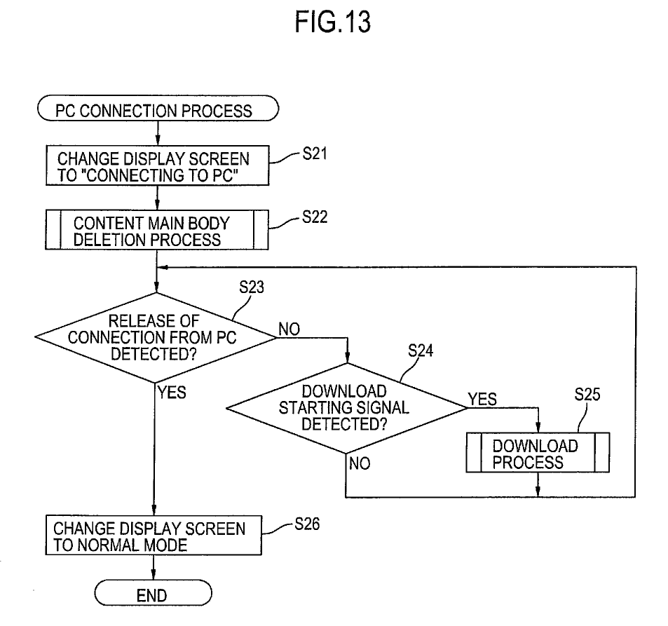

FIG. 3 is a diagram showing a data structure of the memory card 13. As shown in FIG. 13, the memory card 13 has a data structure having three files: a page file 133 including image data or text data, a content management file 132, and a total management file 131. Each page of the page file 133 constitutes one file. If one content has a plurality of pages, a plurality of page files 133 may constitute one content. The content management file 132 manages the page files 133 that belong to each content. The total management file 131 manages all the content management files 132 in the memory card 13.

In the example of FIG. 3, three kinds of contents (content a, content, b, content c), having content IDs of “a”, “b”, and “c” respectively, are stored in the memory card 13.

The content a includes three page files 133a: “a_{—}1.bmp”, “a_{—}2.bmp”, and “a_{—}3.bmp”. The content b includes two page files 133b: “b_{—}1.bmp” and “b_{—}2,bmp”. The content c includes five page files 133c: “c_{—}1.bmp”, “c_{—}2.bmp”, “c_{—}3.bmp” “c_{—}4.bmp”, and “c_{—}5.bmp”. A content management file 132a with a file name “a_index” is provided for the content a. Similarly, a content management file 132b with a file name “b_index” and content management file 132c with a file name “c_index” are provided for the content b and the content c, respectively. And the total management file 131 manages all of these content management files 132.

Each content management file 132 has, as data items, a content ID information 151, a page count information 152 of corresponding content, a page number information 153, a link information 154 to each page files 133, and a last access time information 155 to each page files 133. The total management file 131 has a management number information 141, a content ID information 142, and a link information 143 to respective content files 132, as data items.

As described above, while the content management information and total management information are stored in a file format in the present embodiment, data formats are not limited to the file format. For example, data in a table-type format may be stored in the memory card 13.

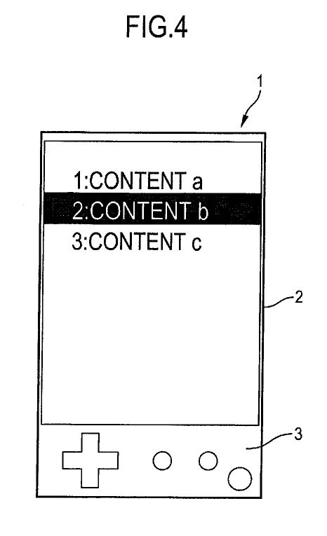

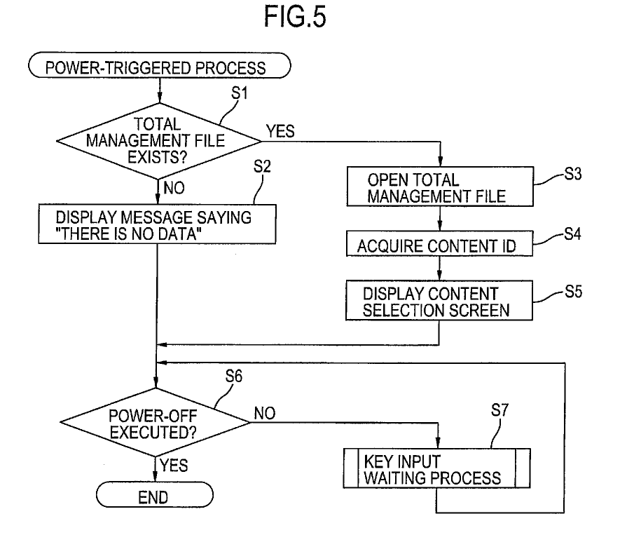

When the memory card 13 having the data structure as shown in FIG. 3 is inserted into the browsing terminal 1 and the browsing terminal 1 is powered, a content selection screen as shown in FIG. 4 is displayed on the display section 2. When a user selects a desired content on the content selection screen, the CPU 10 first accesses the total management file 131 for acquiring the link information 143 to the content management file 132 corresponding to the selected content. Then, the CPU 10 accesses the corresponding content management file 132 based on the acquired link information 143 and acquires the link information 154 to a page file 133 of page number “1”. Finally, the CPU 10 retrieves the page file 133 corresponding to the first page of the target content and displays the page file 133 on the display section 2. Next, various processes executed in the browsing terminal 1 having the configuration described above will be described. First, a power-triggered process will be described with reference to FIGS. 5 through 12.

The power-triggered process is executed when the browsing terminal 1 is powered. As shown in FIG. 5, in the power-triggexed process, the CPU 10 checks the inserted memory card 13 to determine whether there exists a total management file 131 (S1). If the total management file 131 does not exist or the memory card 13 is not inserted (S1: NO), the CPU 10 displays a message, saying “there is no data” or the like, on the display section 2 (S2) and proceeds to SC. Here, the CPU 10 may be configured to return to S1 and wait for the user to insert the memory card 13 storing the total management file 131. On the other hand, if the total management file 131 exists (S1: YES), the CPU 10 opens the total management file 131 (S3) and acquires all the content ID information 142 stored in the total management file 131 (S4). Then, the CPU 10 displays the content selection screen as shown in FIG. 4 on the display section 2 based on the acquired content ID information 142 (S5), and proceeds to S6.

In S6, the CPU 10 determines whether a power-off has been executed. If the power-off has not been executed (S6: NO), the CPU 10 executes a key input waiting process to be described later (S7), and returns to S6 again. In contrast, if the power-off has been executed (S6: YES), the CPU 10 terminates the power-triggered process.

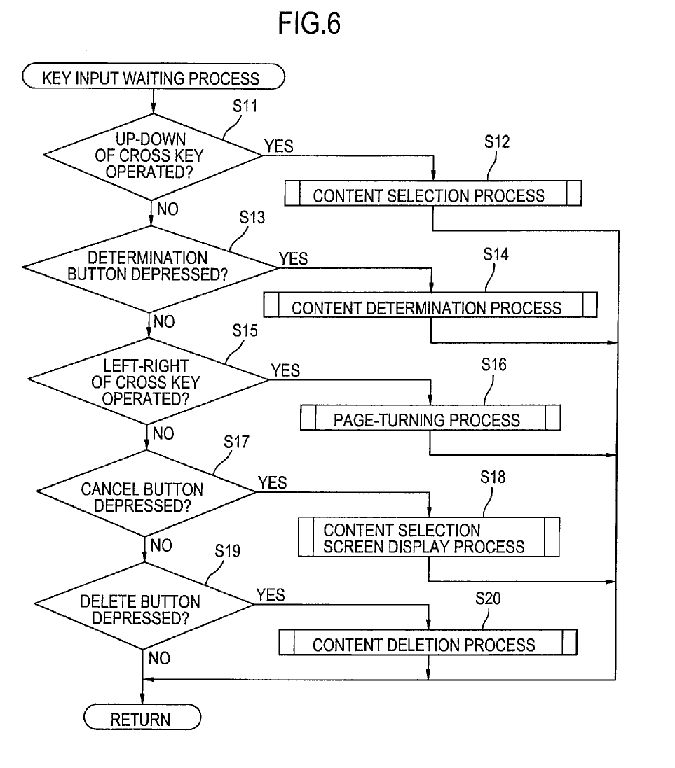

Next, the key input waiting process executed in the power-triggered process will be described with reference to FIG. 6. First, the CPU 10 determines whether an up-down operation of the cross key 31 has been performed (S11). If the up-down operation of the cross key 31 has been performed (S11: YES), the CPU 10 executes a content selection process to be described later (S12) and returns to the power-triggered process.

If the up-down operation of the cross key 31 has not been performed (S11: NO), the CPU 10 determines whether the determination button 32 has been depressed (S13). If the determination button 32 has been depressed (S13: YES), the CPU 10 executes a content determination process to be described later (S14) and returns to the power-triggered process.

If the determination button 32 has not been depressed (S13: NO), the CPU 10 determines whether a left-right operation of the cross key 31 has been performed (S15). If the left-right operation of the cross key 31 has been performed (S15: YES), the CPU 10 executes a page-turning process to be described later (S16) and returns to the power-triggered process.

If the left-right operation of the cross key 31 has not been performed (S15: NO), the CPU determines whether the cancel button 33 has been depressed (S17). If the cancel button 33 has been depressed (S17: YES), the CPU 10 executes a content selection screen display process to be described later (S18) and returns to the power-triggered process.

If the cancel button 33 has not been depressed (S17: NO), the CPU 10 then determines whether the delete button 34 has been depressed (S19), If the delete button 34 has been depressed (S19: YES), the CPU 10 executes a content deletion process to be described later (S20) and returns to the power-triggered process. If the delete button 34 has not been depressed (S19: NO), the CPU 10 directly returns to the power-triggered process.

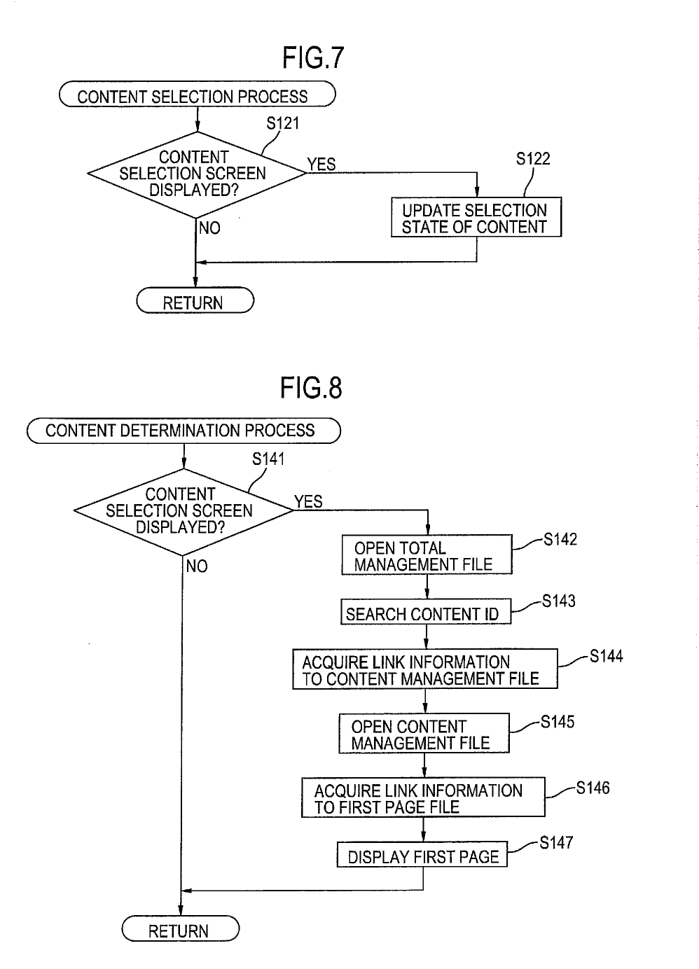

Next, the content selection process executed in S12 of the key input waiting process will be described with reference to FIG. 7. First, the CPU 10 determines whether the content selection screen is being displayed (S121). If the content selection screen is not being displayed (S121: NO), the CPU 10 directly returns to the key input waiting process. If the content selection screen is being displayed (S121: YES), the CPU 10 updates the state of content selected on the content selection screen in accordance with an input from the cross key 31 (S122). More specifically, a selected content is highlighted as shown in FIG. 4. The user can select contents by switching a highlighted content to another. The CPU 10 then returns to the key input waiting process.

Next, the content determination process executed in S14 of the key input waiting process will be described with reference to FIG. 8. First, the CPU 10 determines whether the content selection screen is being displayed (S141). If the content selection screen is not being displayed (S141: NO), the CPU 10 directly returns to the key input waiting process. If the content selection screen is being displayed (S141: YES), the CPU 10 opens the total management file 131 (S142).

Then, the CPU 10 searches the content ID of the selected content (content highlighted on the content selection screen) from the content ID information 142 of the opened total management file 131 (S143). For example, if the content b is selected, the CPU 10 searches the content ID “b” thereof. The CPU 10 then acquires the link information 143 that corresponds to the content ID found as a result of the search (S144), and stores the link information 143 in the RAM 12. In the example of the content b, “b_index” of the content management file 132b is acquired and stored in the RAM 12.

Subsequently, the CPU 10 opens the targeted content management file 132 based on the acquired link information 143 (S145). The CPU 10 then acquires the link information 154 to the first page file 133 from the content management file (S146). The CPU 10 then displays the first page file 133 on the display section 2 according to the acquired link information 154. At the same time, the CPU 10 stores “1” in the RAM 12 as a selected page information indicating the selected page number (S147). For example, since the first page of the content “b” is “b_{—}1.bmp”, the page file “b_{—}1.bmp” is displayed on the display section 2. Throughout the above-described process, since the first page of the selected content is displayed, the CPU 10 ends the content determination process and returns to the key input waiting process.

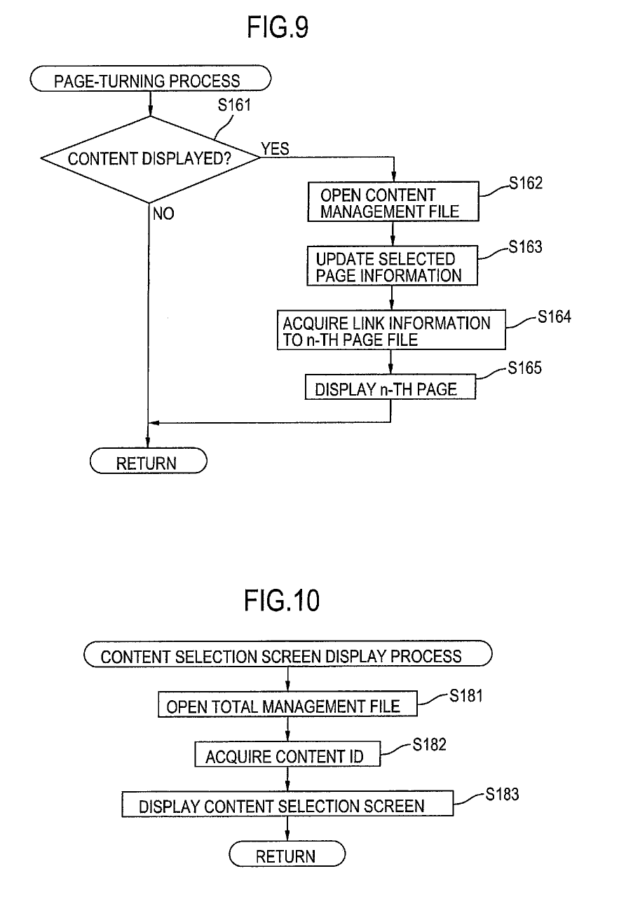

The page-turning process executed in S16 of the key input waiting process will be described next with reference to FIG. 9. First, the CPU 10 determines whether a content is being displayed (S161). If no content is being displayed (for example, when the content selection screen is displayed) (S161: NO), the CPU 10 directly returns to the key input waiting process.

If a content is being displayed (S161: YES), the CPU 10 opens the content management file 132 corresponding to the content being displayed based on the link information 143 stored in the RAM 12 (S162). The CPU 10 then updates the selected page information stored in the RAM 12 in response to the operation performed in S15 of the key input waiting process (S163). More specifically, if the user operates to display a next page (the right operation of the cross key 31), the CPU 10 increments the selected page information by one. If the user operates to display a previous page (the left operation of the cross key 31), the CPU 1C decrements the selected page information by one. Then, the CPU 10 acquires the link information 154 to the n-th page file 133 that corresponds to the page number indicated by the selected page information from the content management file 132 opened in S162 (S164). Based on the link information 154, the CPU 10 displays the n-th page file 133 on the display section 2 (S165).

For example, if the user intends a next page to be displayed by operating the right portion of the cross key 31 when the second page of the content “a” is being displayed, the CPU 10 first opens the content management file 132a (S162), updates the selected page information to the next page (i.e., third page) (S163), acquires the link information 154 to the third page of the page files 133a (i.e., “a_{—}3.bmp”) (S164), and displays the third page of the page files 133a on the display section 2. Throughout the above-described process, since the intended page-turning operation is executed, the CPU 10 ends the page-turning process and returns to the key input waiting process.

The content selection screen display process executed in S18 of the key input waiting process will be described next with reference to FIG. 10. First, as shown in FIG. 10, the CPU 10 opens the total management file 131 (S181). Then, the CPU 10 acquires all the content IDs stored in the content. ID information 142 of the total management file 131 (S182). In the example shown in FIG. 13, “a”, “b”, and “c” are acquired. Based on the acquired content IDs, the CPU 10 displays the content selection screen as shown in FIG. 4 (S183). After the content selection screen is displayed, the CPU 10 returns to the key input waiting process.

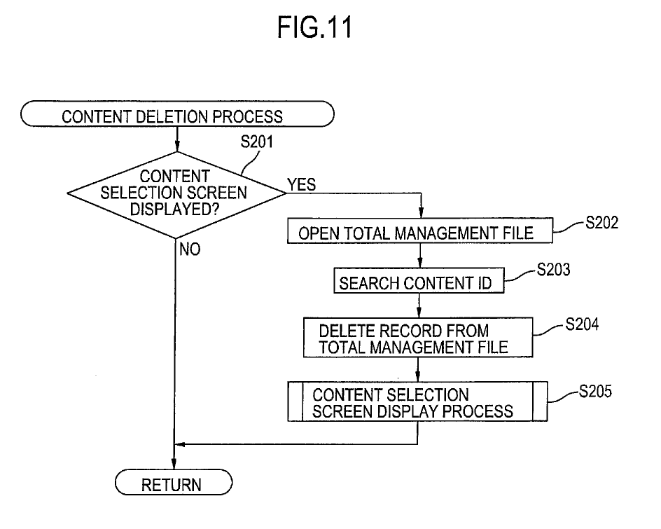

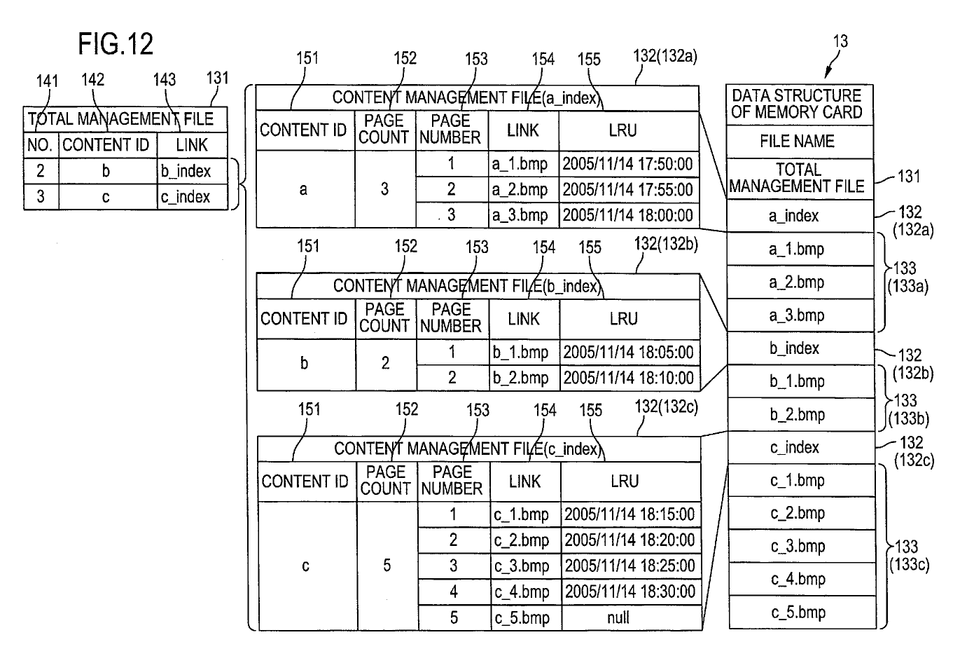

The content deletion process executed in S20 of the key input waiting process will be described next with reference to FIGS. 11 and 12. As shown in FIG. 11, the CPU 10 first determines whether the content selection screen is being displayed (S201). If the content selection screen is not being displayed (S201: NO), the CPU 10 returns to the key input waiting process.

If the content selection screen is being displayed (S201: YES), the CPU 10 opens the total management file 131 (S202). Then, the CPU 10 searches the content ID of the selected content (S202). For example, if the content a is selected to be deleted, the CPU 10 searches the content ID “a” thereof.

Next, the CPU 10 deletes the records (management number information 141, content ID information 142 and link information 143) that correspond to the selected content from the total management file 131 (S204). For example, in the memory card 13 having data structure shown in FIG. 3, if the content a is selected to be deleted, the CPU 10 deletes the records corresponding to the content a. As a result, the total management file 131 has changed as shown in FIG. 12. Note that, here, the CPU 10 only deletes the corresponding records from the total management file 131, but does not delete the content management file 132a and the page files 133a.

Next, the CPU 10 executes the content selection screen display process shown in FIG. 10 (S205) and returns to the key input waiting process. Here, when the CPU 10 executes the content selection screen display process, the CPU 10 opens the total management file 131 in which the records corresponding to the selected content have already been deleted (FIG. 10, S181). According to the content ID 142 acquired from the total management file 131 (FIG. 10, S182), the CPU 10 then displays the content selection screen (FIG. 10, S183). Hence, although the page files 133a and the content management file 132a have not actually been deleted it seems for the user that the page files 133a have been deleted since the content a is no longer displayed on the content selection screen. Since the page files 133a and content management file 132a are not deleted, power consumption involved with the deletion of the information can be suppressed. As described later, in the present embodiment, the page files 133a and the content management file 132a are actually deleted when the browsing terminal 1 is connected to the management information generation apparatus 5 (see FIG. 13, S22).

Next, PC connection process executed in the browsing terminal 1 will be described with reference to FIG. 13. Irrespective of whether the above-mentioned power-triggered process is being executed, or irrespective of whether the browsing terminal 1 is powered, the CPU 10 always gives priority for the PC connection process to start by interrupting processes being executed upon detecting connection between the browsing terminal 1 and management information generation apparatus 5.

First, the CPU 10 displays a screen saying “connecting to PC” on the display section 2 (S21). Then, the CPU 10 executes a content, main body deletion process to be described later (S22). The content main body deletion process is for deleting contents designated as targets of the content deletion process on the browsing terminal 1 during a period from the previous connecting time until the current connecting time.

Next, the CPU 10 determines whether the connection with the management information generation apparatus 5 has been released (S23). If the CPU 10 detects the connection has been released (S23: YES), the CPU 10 returns the display of the display section 2 to a normal mode (e.g., the content selection screen or the content display screen) (S26), and ends the PC connection process. If the CPU 10 does not detect the connection with the management information generation apparatus 5 has been released (S23: NO), the CPU 10 then determines whether a download starting signal has been detected (S24). Note that, the download starting signal is transmitted from the management information generation apparatus 5 to the browsing terminal 1 when the user inputs a download starting instruction into the management information generation apparatus 5. If the CPU 10 does not detect the download starting signal (S24: NO), the CPU 10 returns to S23. In contrast, if the CPU 10 detects the download starting signal (S24: YES), the CPU 10 executes a download process to be described later (S25) and the returns to S23.

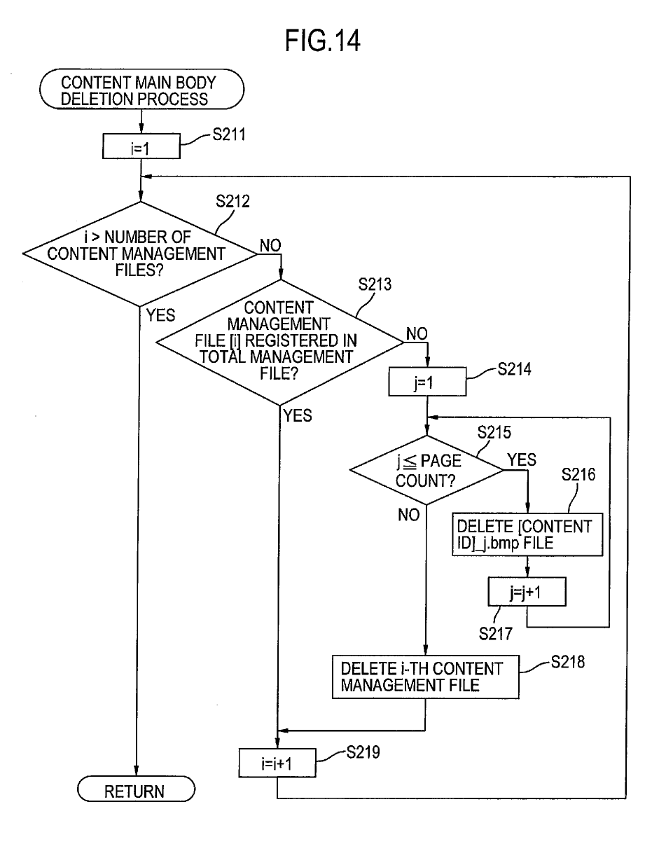

Next, the content main body deletion process executed in S22 of the PC connection process will be described with reference to FIG. 14. First, as shown in FIG. 14, the CPU 10 initializes a variable i to 1 (S211). The variable i is set as an i-th content management file subject for deletion. Then, the CPU 10 counts the number of the content management files 132 existing in the memory card 13, and determines whether the counted number is smaller than the variable i (S212).

If the number of the content management files 132 is not smaller than the variable i (S212: NO), the CPU 10 determines whether an i-th content management file 132 (here, if i=1, the i-th content management file is “a_index”, the first content management file 132a; if i=2, the i-th content management file is “b_index”, the second content management file 132b; if i=3, the i-th content management file is “c_index”, the third content management file 132c) is registered in the total management file 131 (S213). If the i-th content management file 132 is registered in the total management file 131 (S213: YES), the CPU 10 adds 1 to the variable 1 (S219) and returns to S212, since the deleting process need not be executed for the i-th content.

In contrast, if the i-th content management file 132 is not registered in the total management file 131 (S213: NO), which means that a record corresponding to the content management file 132 has already been deleted through the content deletion process, the CPU 10 deletes the content management file 132 as well as the corresponding page files 133 as follows.

First, the CPU initializes a variable j to 1 (S214). The variable j is set as a j-th page file 133 of the i-th content management file 132. Then, the CPU 10 acquires the page count information 152 from the i-th content management file 132 (when i=1, for example, the first content management file 132a), and determines whether the value of the page count information 152 is equal to or larger than the value of the variable j (S215). If the value of the page count information 152 is equal to or larger than the value of the variable j (S215: YES), the CPU 10 deletes the j-th page file 133 of the i-th content management file (when j=1, the first page file “a_{—}1.bmp”) (S216). Then, the CPU 10 adds 1 to the variable j (S217) and returns to S215.

The CPU 10 repeats the steps from S215 to S217 until all the page files 133 are deleted when the value of the variable j exceeds the value of the page count information 152 in S215 (S215: NO), which means that all the page files 133 have been deleted, the CPU 10 deletes the i-th content management file 132 from the memory card 13 (S218).

In the example of FIG. 12, the link information 154 to the three page files 133a (“a_{—}1.bmp”, “a_{—}2.bmp”, “a_{—}3.bmp”) is stored in the content management file 132a. Hence, when i=1, the CPU 10 repeats the steps from S215 to S217 three times (i.e., the CPU 10 loops the steps from S215 to S217 for the number of times corresponding to the page count). More specifically, the CPU 10 deletes “a_{—}1.bmp” at the first loop (S216), “a_{—}2.bmp” at the second loop (S216), and “a_{—}3.bmp” at the third loop (S216).

When the content management file 132 has been deleted in S218, the CPU 10 adds 1 to the variable i (S219) and returns to S212. In the example of FIG. 12, the CPU 10 executes the steps from S214 to S218 for the second content management file 132b (i=2) and the third content management file 132c (i=3) in this order. However, since the content management file 132b and content management file 132c are both registered in the total management file 131 (S213: YES), the CPU 10 skips the steps from S214 to S218 and returns to S212.

If the number of the content management files 132 is smaller than the variable i (S212: YES), which means that the content management file 132 registered in the total management file 131 has been aligned with the content management file 132 and the page files 133 corresponding thereto stored in the memory card 13, the CPU 10 ends the content main body deletion process and returns to the PC connection process.

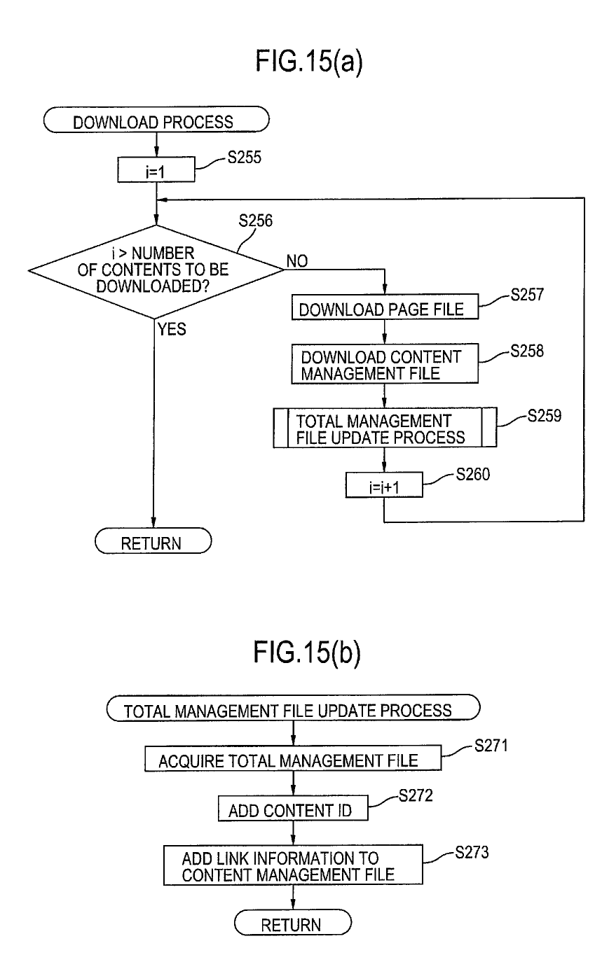

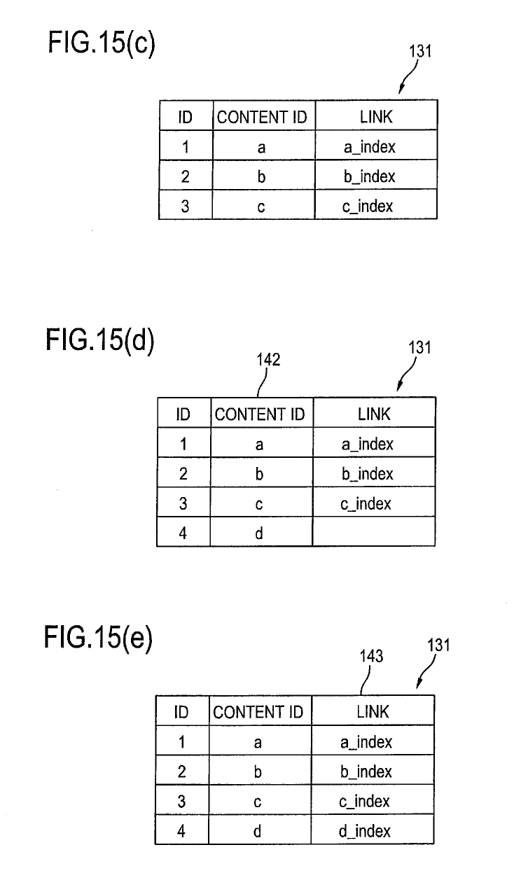

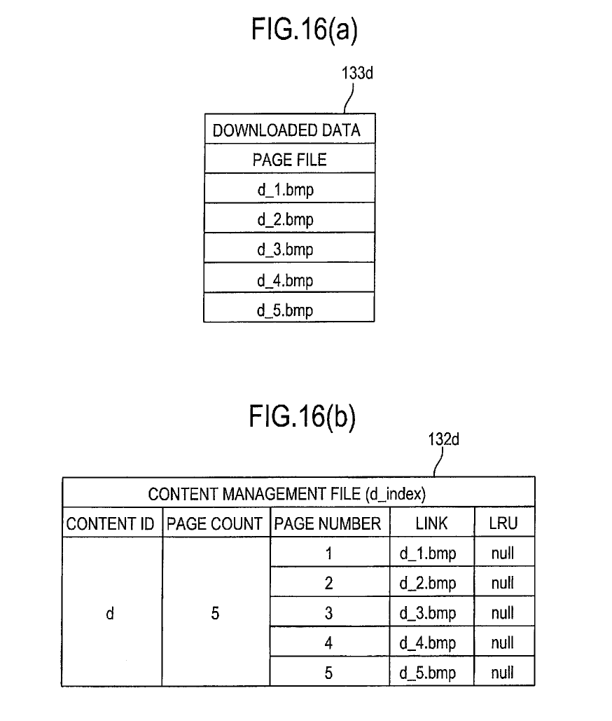

The download process executed in the PC connection process will be described next with reference to FIGS. 15(a) through 16(b). In the download process, the CPU 10 downloads the page files 133 and content management file 132 generated in advance through the page generation process in the management information generation apparatus 5, and updates the total management file 131 based on the downloaded content management file 132. The file generation process executed in the management information apparatus 5 will be described later.

X First, as shown in FIG. 15(a), the CPU 10 initializes a variable i to 1 (S255). Here, the variable i is set as an i-th content to be downloaded. Then, the CPU 10 determines whether a number of contents to be downloaded is smaller than the value of the variable i (S256). Note that, the number of contents to be downloaded is transmitted from the management information generation apparatus 5 together with the download starting signal. If the number of contents to be downloaded is not smaller than the value of the variable i (S256: NO), the CPU 10 first downloads the page file 133 of the i-th content to be downloaded (S257). When a plurality of page files 133 exists in the i-th content to be downloaded, the CPU 10 downloads all the page files 133.

Next, the CPU 10 downloads the content management file 132 of the i-th content to be downloaded (S258) and executes a total management file update process to be described later (S259). Now that the download process for one content has been completed, the CPU 10 adds 1 to the variable i (S260) and returns to S256.

When the value of the variable i exceeds the number of the contents to be downloaded (S256: YES), which means that the download process for all the contents to be downloaded has been completed, the CPU 10 returns to the PC connection process.

The total management file update process executed in S259 of the download process will be described next with reference to FIG. 15(b). First, the CPU 10 acquires the total management file 131 as shown in FIG. 15(c) from the memory card 13 (S271). Then, as shown in FIG. 15(d), the CPU 10 adds a new record to the total management file 131. The CPU 10 then adds a content ID acquired from the content management file 132 (downloaded in S258) to the content ID information 142 of the new record (S272). Then, as shown in FIG. 15(e), the CPU 10 adds the link information 143 to the content management file 132 corresponding to the acquired content ID (S273), and returns to the download process.

Here, as an explanatory example, a content d having five page files 133d as shown in FIG. 16(a) is assumed to be downloaded when the data structure of the memory card 13 before the download process is as shown in FIG. 3. In this case, the total management file 131 before the download process has the content ID information 142 corresponding to the three contents; the content a, content b, and content c. The CPU 10 downloads the five page files 133d (FIG. 16(a)) of the content d to this total management file 131 (S257), and subsequently downloads the corresponding content management file 132d (FIG. 16(b)) (S258). The CPU 10 finally updates the total management file 131 as shown in FIG. 15(e) (S259). As a result, the total management file 131 having four records of the content a, content b, content c, and content d is stored in the memory card 13.

As described above, when executing a download from the management information generation apparatus 5, the CPU 10 first downloads the page file 133 and subsequently the content management file 132, and then updates the total management file 131 based on the downloaded content management file 132. This configuration can prevent the data structure from becoming inconsistent at the browsing terminal 1 when the browsing terminal 1 is accidentally disconnected from the management information generation apparatus 5 for some reason (For example, no corresponding page file 133 exists even though the content management file 132 has the link information 154).

Next, the management information generation apparatus 5 will be described with reference to FIG. 17. FIG. 17 is a functional block diagram of the management information generation apparatus 5.

The management information generation apparatus 5 is a commonly-used computer and includes a communication unit 95 that can be connected to the browsing terminal 1.

The management information generation apparatus 5 also includes a CPU 90 for controlling the management information generation apparatus 5. A RAM 91, a ROM 92, and an I/O interface 93 are connected to the CPU 90. The RAM 92 temporarily stores various data, a ROM 92 stores BIOS and the like, and an I/O interface mediates data exchange. A hard disk drive 94 is connected to the I/O interface 93 and stores data such as various programs executed by the CPU 90 and original data of the page file 133.

Further, a video controller 97, a key controller 98, a CD-ROM drive 99, and the communication unit 95 are connected to the I/O interface 93. A display 100 is connected to the video controller 97. A keyboard 101 is connected to the key controller 98. The communication unit 95 can be connected to the Internet via a router (not shown). A CD-ROM 102 is inserted into the CD-ROM drive 99 and stores a program for controlling the management information generation apparatus 5. The control program is set up to the hard disk drive 94 from the CD-ROM 102 upon installation.

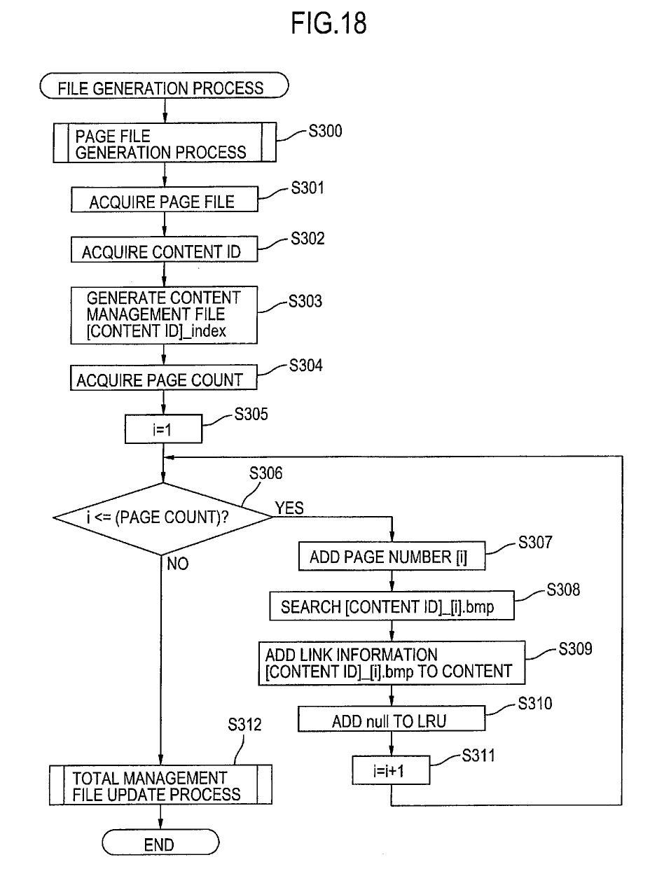

Next, a file generation process executed in the management information generation apparatus 5 will be described with reference to FIGS. 18 through 27. In the file generation process, the CPU 90 generates the page files 133 and the content management file 132, and updates the total management file 231.

As shown in FIG. 18, the CPU 90 first executes a page file generation process to be described later to generate the page file 133 (S300). Then, the CPU 90 acquires the page files 133 generated in S300 (S301). The CPU 90 then acquires a content ID from the page files 133 acquired in S301 (S302). In the present embodiment, since a file name of the page file 133 is generated according to the rule “[content. ID]_[page number].bmp”, the CPU 90 can acquire the content ID from the file name of the page file 133. Alternatively, instead of employing such a rule, the CPU 90 may acquire a content ID from a separate database in which a content ID and a file name are associated with each other.

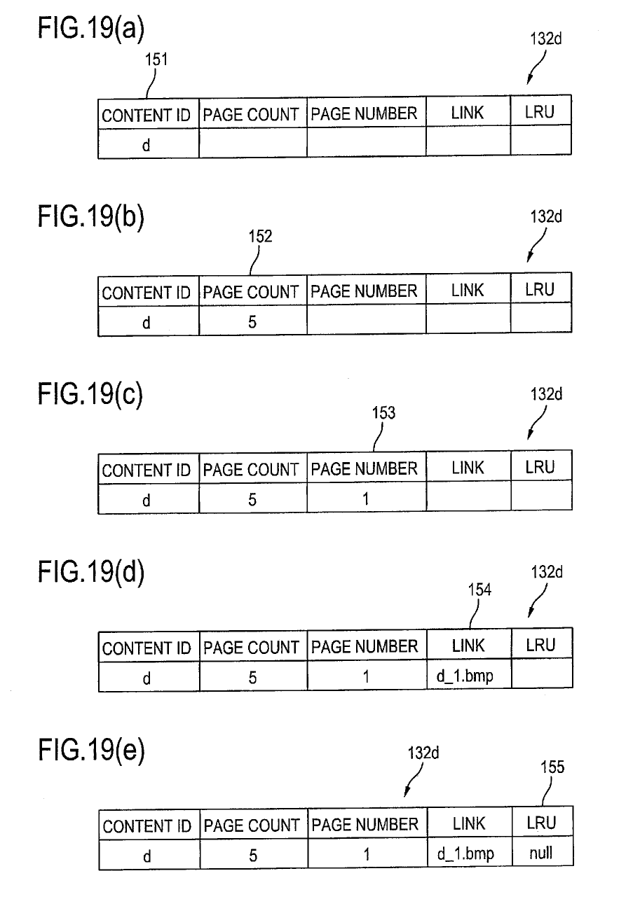

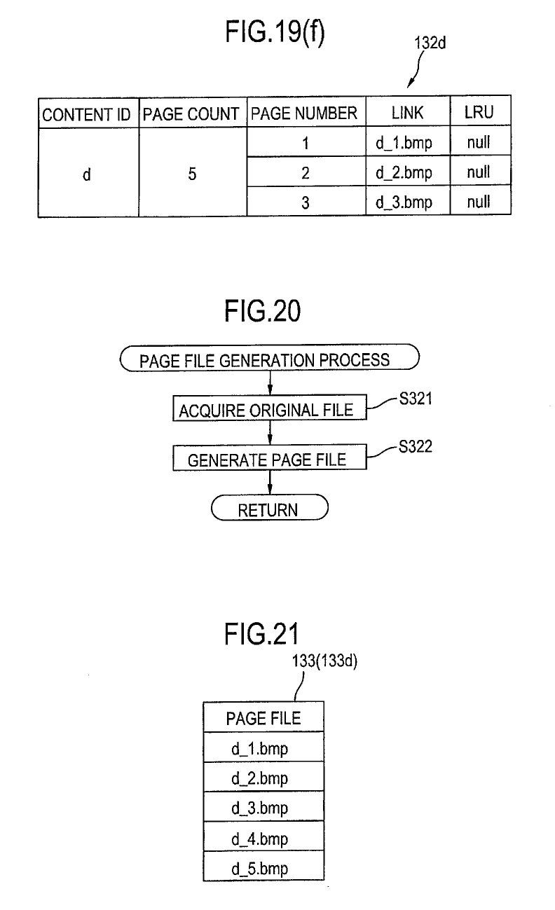

Next, the CPU 90 generates the content management file 132 and designates a file name as “[content ID]_index” (S303). For example, if the content ID acquired in S302 is “d”, the CPU 90 generates a content management file 132d storing “d” as the content ID information 151 as shown in FIG. 19(a).

Then, the CPU 90 acquires a total page count from the file names of the page files 133 and stores, as the page count information 152, in the content management file 132 generated in S303 (S304). For example, if the total page count of the content d is 5, the CPU 90 stores “5” as the page count information 152 as shown in FIG. 19(b).

Then the CPU 90 assigns 1 to a variable i (S305). Here, the variable i is set as an i-th page number. The CPU 90 determines whether the value of the variable i is equal to or smaller than the total page count acquired in S304 (S306). If the value of the variable i is equal to or smaller than the total page count (S306: YES), the CPU 90 adds a record of [i] to the page number information 153 in the content management file 132 (S307). In the example of the content management file 132d, as shown in FIG. 19(c), 1 is added to the page number information 153. Then, the CPU 90 searches the i-th page file 133 from all the page files 133 acquired in S301 (S308).

Then, as shown in FIG. 19(d), the CPU 90 adds the link information 154 associated with the applicable page number (i.e., the link information 154 to the i-th page file 133) to the content management file 132 (S309), and adds a null value as a last access time information (LRU) 155 as shown in FIG. 19(e) (S310). The CPU 90 then adds 1 to the variable i (S311) and returns to S306 to generate a record corresponding to the subsequent page number. The content management file 132d after the third loop (i=3) is shown in FIG. 19(f) as an example. The CPU 90 loops the steps S306 to S311 until the variable 1 exceeds the total page count acquired in S304.

When the value of the variable i exceeds the total page count acquired in S304 (S306: NO), the CPU 90 executes a total management file update process to be described later (S312) and subsequently ends the file generation process.

Next, the page file generation process executed in S300 of the file generation process will be described with reference to FIG. 20. First, the CPU 90 acquires an original file of the page files 133 (S321). Then, the CPU 90 divides the acquired original file into each page and generates the page files 133 (133d) as shown in FIG. 21. The CPU 90 stores the generated page files 133 in the hard disk drive 94 (S322). Now that the page files 133 have been generated in page units, the CPU 90 returns to the file generation process.

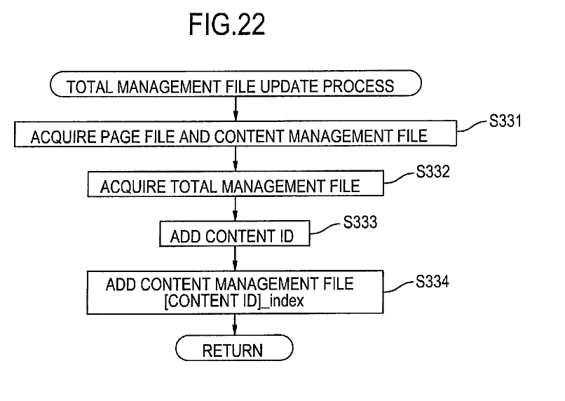

The total management file update process executed in S312 of the file generation process will be described next with reference to FIG. 22. The total management file update process executed in the management information generation apparatus 5 is almost identical to the total management file update process executed in the browsing terminal 1 (see FIG. 15(b)). First, the CPU 90 acquires the page files 133 and the content management file 132 generated in the steps from S300 to S311 (S331). Then, the CPU 90 acquires the existing total management file 231 (see FIG. 3) from the hard disk drive 94 (S232). Note that the total management file 231 has the same data structure as the total management file 131.

The CPU 90 adds a new record to the total management file 231 and, to the content ID information 142 of the new record, further adds the content ID acquired from the content ID information 151 of the content management file 132 acquired in S331 (S333). Then, the CPU adds the link information 143 “[content ID]_index” to the content management file 132 corresponding to the content ID (S334). The CPU 90 then returns to the file generation process.

Here, note that the total management file 231 need not be stored in the management information generation apparatus 5. If the total management file 231 is not stored in the management information generation apparatus 5 in the file generation process, the CPU 90 may not execute the total management file update process (S312 in FIG. 18) and simply end the file generation process. Further, the content management file 132 may not be generated in the management information generation apparatus 5. Instead, both generation of the content management file 132 and the update of the total management file 131 may be executed in the browsing terminal 1, after the page files 133 are downloaded. In this case, in stead of S258 in FIG. 15(a), the steps from S301 to S311 in the file generation process (FIG. 18) may be executed in the browsing terminal 1.

The generation of the content management file 132 in the management information generation apparatus 5 allows the file generation to be executed at high speed, and at the same time, the browsing terminal 1 need not necessarily have high processing capability. On the other hand, the generation of the content management file 132 in the browsing terminal 1 allows the data consistency with the page files 133 to be easily maintained.

As described above, in the browsing terminal 1 according to the present embodiment, when a content needs to be displayed in the display section 2, the CPU 90 first opens the total management file 131 and acquires the link information 143 therefrom, then opens the content management file 132 from the acquired link information 143 and, finally, opens a target page file 133 based on the link information 154 in the content management file 132. Hence, even if the number of the page files 133 is large, the time required to access the target page file 133 can be reduced.

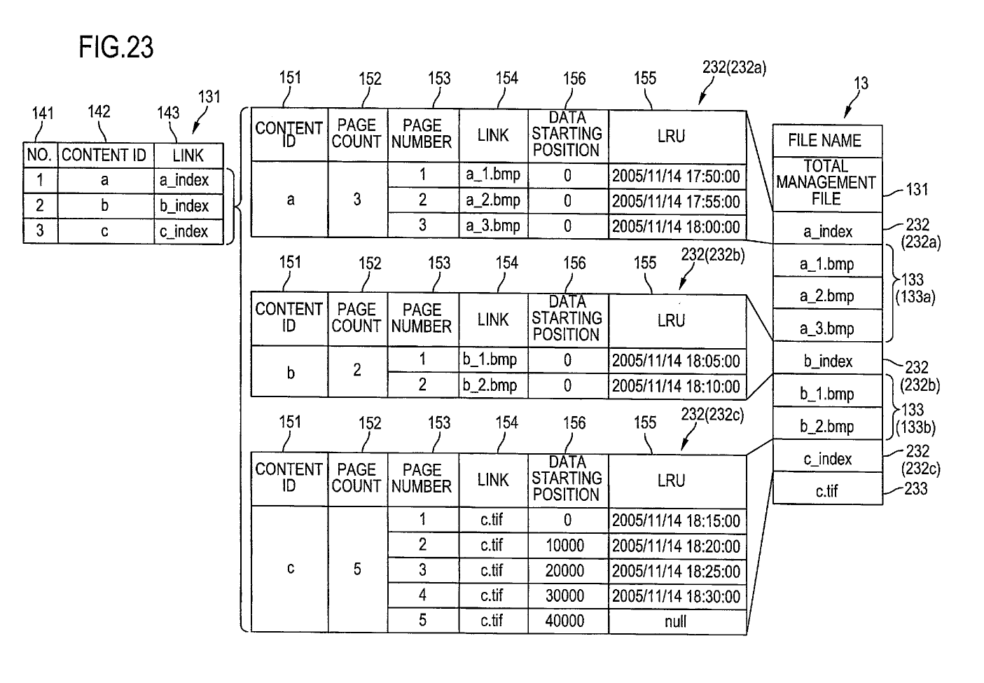

Further, while one page constitutes one page file 133 in the above embodiment, the file structure of the page file 133 is not limited to this configuration but a plurality of pages may constitute one page file 133. Next, one of such modifications will be described with reference to FIG. 23. FIG. 23 is an explanatory view showing a data structure of the memory card 13 storing a page file 233 having a plurality of pages.

As shown in FIG. 23, the memory card 13 stores the page files 133a, 133b, 233, the corresponding content management files 232a, 232b, 232c respectively, and the total management file 131. The total management file 131 has the same configuration as that in the above embodiment (see FIG. 3). Each of the content management files 232a, 232b, and 232c further includes a data starting position information 156 as a data item, in addition to the content ID information 142, the page count information 152, the page number information 153, the link information 154 to corresponding contents, and the last access time information 155. The page file 233 is constituted by one file with a file name “c.tif”. The data starting position information 156 stores information indicating at which point the page file 133 (233) is to be displayed on the display section 2. Hence, in the case of the page files 132a and 132b, respective data starting point is set to 0 since one page constitutes each page file. In the case of the page file 233, since a plurality of pages constitutes one page file, the data starting position for each page is set such that the entire data for each page can be displayed within the display area of the display panel 2. In the example of FIG. 23, 1 is set as the data starting position for the first page, 10000 for the second page, and 20000 for the third page, and so forth.

With the data structure of the memory card 13 described above, when displaying a content stored in the memory card 13 at the browsing terminal 1, the CPU 10 can acquire the data starting position information 156 in addition to the link information 154 in S164 of the page-turning process (FIG. 9), and display a target page based on the both acquired information.

The present invention is not limited to the above-described embodiments and it would be apparent to those skilled in the art that many modifications and variations may be made therein without departing from the spirit of the invention, the scope of which is defined by the attached claims.

For example, the browsing terminal 1 may receive the total management information 231 updated in the management information generation apparatus 5 and store the received total management information 231 as the total management information 131, in stead of updating the total management information 131 based on the received content management information 132. In this case, the total management information generation apparatus 5 transmits the page information 133, the content management information 132, and the total management information 231 in this order to the browsing terminal 1.

Further, while power is supplied when the browsing terminal 1 is connected to a PC according to the embodiment of the present invention, the browsing terminal 1 may have a power-supplying section therein. With this configuration, the browsing terminal 1 alone may perform the content main body deletion process without connecting to the PC.

What is claimed is:

1. A data structure for allowing a user to browse a content on a computer, the data structure comprising:
page information that has one page worth of data including at least one of text and image data, one or a plurality of pieces of the page information constituting the content;
content management information provided for each content and having first link information navigating to each piece of the page information; and
total management information having second link information navigating to the content management information,
wherein the computer firstly accesses the total management information and is navigated to the content management information by virtue of the second link information, and then to the page information by virtue of the first link information when retrieving the page information.

2. A computer-readable storage medium that stores data having a data structure comprising:
page information that has one page worth of data including at least one of text and image data, one or a plurality of pieces of the page information constituting the content;
content management information provided for each content and having first link information to navigating to each piece of the page information; and
total management information having second link information navigating to the content management information,
wherein a computer firstly accesses the total management information and is navigated to the content management information by virtue of the second link information, and then to the page information by virtue of the first link information when retrieving the page information.

3. A storage medium that stores a computer-executable program, the program including instructions comprising:
generating and storing page information that has one page worth of data including at least one of text and image data, one or a plurality of pieces of the page information constituting the content;
generating and storing content management information for each content, the content management information having first link information navigating to each piece of the page information belonging to the same content; and
generating and storing total management information that has second link information navigating to the content management information.

4. The storage medium according to claim 3, the instructions further comprising updating the total management information.

5. The storage medium according to claim 3, the instructions further comprising transmitting firstly the page information, secondly the content management information, and finally the total management information, to an external terminal, for each content, for browsing the page information on the external terminal, when a plurality of contents is to be transmitted.

6. The storage medium according to claim 3, the instructions further comprising:
updating total management information; and
transmitting firstly the page information, secondly the content management information, and finally the total management information, to an external terminal, for each content, for browsing the page information on the external terminal, when a plurality of contents is to be transmitted.

7. A browsing terminal for allowing a user to browse a content thereon, the browsing terminal comprising:
page information that has one page worth of data including at least one of text and image data, one or a plurality of pieces of the page information constituting the content;
a display section that displays the page information;
a storing section that stores the page information, content management information and total management information, the content management information being provided for each content and having first link information navigating to each piece of the page information, and the total management information having second link information navigating to the content management information; and
a retrieving section that retrieves the page information from the storing section when a user inputs a display request for requesting the display section to display the page information, and outputs the page information to the display section,
wherein the retrieving section firstly accesses the total management information and is navigated to the content management information by virtue of the second link information, and then to the page information by virtue of the first link information when retrieving the page information.

8. The browsing terminal according to claim 7, further comprising:
a deletion request inputting section that inputs a request for deleting a content;
a first deleting section that deletes the second link information from the total management information when a deletion request has been input from the deletion request inputting section, the second link information navigating to the content targeted for deletion;
a deletion determining section that determines whether the first deleting section has deleted any of the second link information from the total management information; and
a second deleting section that deletes both the page information belonging to the content and the corresponding content management information from the storing section, when the deletion determining section determines that the first deleting section has deleted the second link information.

9. The browsing terminal according to claim 8, further comprising a power supplying section that supplies power from an outside source,
wherein the deletion determining section determines whether the first deleting section has deleted any of the second link information from the total management information when power is supplied from the power supplying section.

10. The browsing terminal according to claim 7, further comprising:
a receiving section that receives the page information and the content management information from outside; and
a total management information updating section that updates the total management information based on the content management information received by the receiving section.

11. The browsing terminal according to claim 10, wherein the receiving section receives firstly the page information and subsequently the content management information from outside.

12. The browsing terminal according to claim 11, wherein the receiving section receives firstly the page information and subsequently the content management information for each content when the page information for a plurality of contents is to be received.

13. The browsing terminal according to claim 7, further comprising:
a receiving section that receives the page information from outside;
a management information generating section that generates the content management information based on the page information received by the receiving section; and
a total management information updating section that updates the total management information based on the content management information generated by the management information generating section.

14. A management information generation apparatus comprising:
a page storing section that stores page information having one page worth of data including at least one of text and image data, one or a plurality of pieces of the page information constituting the content;
a content management information generating section that generates, for each content, content management information having first link information navigating to each piece of the page information belonging to the same content; and
a transmitting section that transmits the page information and the content management information to a browsing terminal for browsing the page information thereon.

15. The management information generation apparatus according to claim 14, wherein the transmitting section transmits to the browsing terminal firstly the page information and subsequently the content management information.

16. The management information generation apparatus according to claim 15, further comprising:
a total management information generating section that generates total management information having second link information navigating to the content management information; and
a total management information updating section that updates the total management information,
wherein the transmitting section transmits to the browsing terminal firstly the page information, subsequently the content management information, and finally the total management information.

17. The management information generation apparatus according to claim 15, wherein the transmitting section transmits to the browsing terminal, for each content, firstly the page information and subsequently the content management information when the page information for a plurality of contents is to be transmitted.

18. The management information generation apparatus according to claim 17, further comprising:
a total management information generating section that generates total management information having second link information navigating to the content management information; and
a total management information updating section that updates the total management information,
wherein the transmitting section transmits to the browsing terminal, for each content, firstly the page information, secondly the content management information, and finally the total management information when the page information for a plurality of contents is to be transmitted.

19. A management information generation apparatus storing a set of program instructions executable on a computer, the set of program instructions comprising:
generating and storing page information that has one page worth of data including at least one of text and image data, one or a plurality of pieces of the page information constituting the content;
generating and storing content management information for each content, the content management information having first link information navigating to each piece of the page information belonging to the same content;
generating and storing total management information having second link information navigating to the content management information;
updating the total management information; and
transmitting firstly the page information, secondly the content management information, and finally the total management information, to a browsing terminal, for each content, for browsing the page information on the browsing terminal, when a plurality of contents is to be transmitted.
